(19) United States
(12) Patent Application Publication
(10) Pub. No.: US 2021/0221270 A1
(43) Pub. Date: Jul. 22, 2021

(54) Active Cushion Shape Adjustment for Vehicle Seats

(71) Applicant: Sears Manufacturing Co., Davenport, IA (US)

(72) Inventor: Wayne Ward, Bettendorf, IA (US)

(21) Appl. No.: 17/257,338

(22) PCT Filed: Jul. 23, 2019
(86) PCT No.: PCT/US19/42954

§ 371 Date: Dec. 31, 2020

Related U.S. Application Data
(60) Provisional application No. 62/701,889, filed on Jul. 23, 2018.

(51) Int. Cl. B60N 2/90; B60N 2/14

(52) U.S. Cl. CPC B60N 2/914; B60N 2002/0272; B60N 2/99; B60N 2/14

(57) ABSTRACT

A seat bolster control system for a vehicle seat including an adjustable seat with adjustable bolsters, a sensor capable of sensing a position of the adjustable seat, a controller in communication with the sensor and an adjusting device which can control adjustment of the adjustable bolsters. The seat bolster control system can automatically adjust based on the position of the adjustable seat, such as if the adjustable seat moves away from a neutral position.

### CROSS REFERENCE TO RELATED APPLICATIONS

This application claims priority to U.S. provisional application entitled Active Cushion Shape Adjustment for Vehicle Seats, U.S. Ser. No. 62/701,889, filed Jul. 23, 2018, which is hereby incorporated by reference in its entirety.

### BACKGROUND

Vehicle seats often utilize bolsters on the side of the seat back and seat bottom to assist the occupant in remaining centered within the seat. In particular, bolsters are configured to project upward from the plane of the seat cushion at the sides of the seat to bear against the occupant's thighs to help maintain the occupant in a fixed position, particularly during vehicle maneuvers that might otherwise cause the occupant to shift laterally within the seat. Similar bolsters have been incorporated into the seat back to help maintain the position of the occupant.

Because occupants can vary greatly in size, many bolsters are adjustable to adjust the distance or area between lateral bolsters. In addition, the adjustable bolsters account for variations in user comfort, with some occupants preferring a tight fit and others preferring a looser fit in the seat. Adjustable bolsters are common in seats for work vehicles, such as tractors, forklift trucks and the like. Operators of work vehicles frequently need to turn in the driver's seat to navigate the vehicle in reverse. It is critical that the vehicle operator has a full view to the rear of the vehicle, particularly in a work environment to avoid collisions with equipment, products and personnel. Consequently, many work vehicles include a seat that can swivel through an angular range of motion so that the vehicle operator is not limited in his/her movement by the seat itself. In some vehicles, the entire seat is configured to pivot about a vertical axis, such as shown in U.S. Pat. Nos. 5,599,065 or 6,447,065. In other vehicles, only the seat bottom is configured to pivot.

In seats with bolsters, the bolsters themselves can limit the degree of movement of the vehicle operator. This problem is particularly pronounced for vehicle operators that generally prefer to have a deeper bolster shape, in which case the bolster is expanded to its maximum height or shape. While the deep bolster configuration is good for normal driving of the vehicle, the deep bolsters can restrict the vehicle operator's ability to turn or pivot far enough to have a complete view to the rear of the vehicle. Consequently, there is a need for a bolster system that avoids these problems. The present disclosure overcomes these difficulties by providing an active bolster system that can react to the position of an adjustable vehicle seat.

### SUMMARY

In one disclosed embodiment, a seat bolster control system comprising an adjustable seat containing at least one adjustable bolster, a sensor capable of sensing a position of the adjustable seat, a controller in communication with the sensor and an adjusting device which can control adjustment of the adjustable bolsters is disclosed. In another disclosed embodiment, the adjustable bolsters can be adjusted independently of each other. This adjustment can be by means of inflation.

In certain embodiments, the adjusting device automatically adjusts the adjustable bolsters based on the position of the adjustable seat, such as if the seat body or seat cushion swivels away from a neutral position. When the adjustable seat is adjusted away from a neutral position, the bolsters are deactivated. The adjusting device can also adjust the adjustable bolsters based on an altitude adjustment of the adjustable seat.

In an additional aspect of the disclosure, a method of adjusting a bolster is disclosed. This method includes sensing an adjustment of an adjustable seat, sending a signal to a controller, wherein the controller sends a signal to an adjustment device to adjust the adjustable bolster. The signal may be an electrical, optical or mechanical signal.

The disclosed adjustment device may be a pneumatic device.

Further aspects of the disclosure will become apparent from the drawings and the following detailed description.

### DESCRIPTION OF THE DRAWINGS

FIG. 1 is a perspective view of a vehicle seat with bolsters for the seat back and seat bottom.

FIG. 2 is a front partial cut-away view of a bolster mechanism for the seat of FIG. 1.

FIG. 3 is a front partial cut-away view of another bolster mechanism for the seat of FIG. 1.

FIGS. 4a-4c are views of a swivel seat, with the seat shown in two pivoted positions and a neutral centered position.

FIG. 5 is a schematic of a bolster control system according one embodiment of the present disclosure.

FIG. 6 is a diagram of a bolster control system according to another embodiment of the present disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

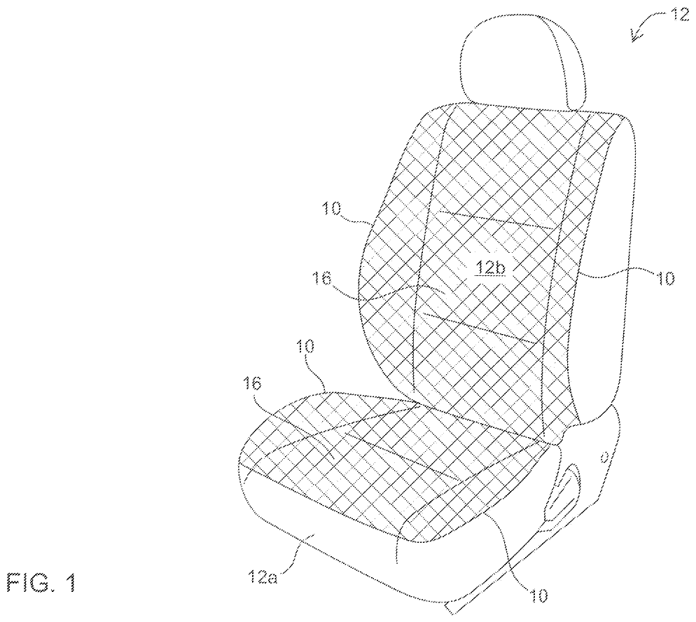

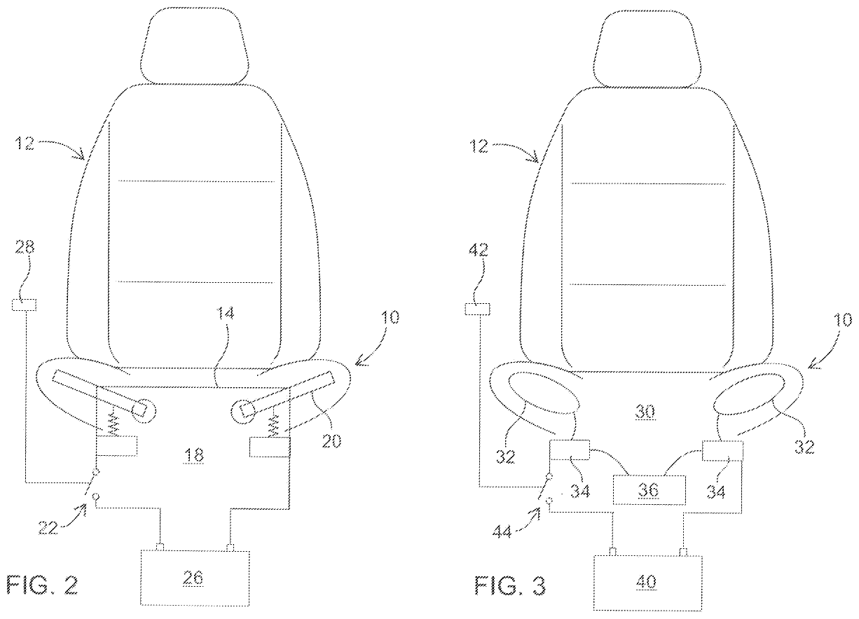

FIG. 1 illustrates a typical vehicle seat 12 with a seat bottom 12a and a seat back 12b. Each component of the seat includes bolsters 10 at the sides of the component and particularly at the sides of the surfaces 16 that support the occupant within the seat 12. In the past, various mechanisms have been developed to adjust the shape or profile of seat bolsters, ranging from purely mechanical, such as the apparatus depicted in FIG. 2, to pneumatic/hydraulic systems, such as the apparatus depicted in FIG. 3. As shown in FIG. 2, an internal actuator assembly 18 includes an active material element 14 that is coupled to an arm 20 within each bolster 10. The active material element 14 is connected to an electrical power supply 26 with a controller 28 that controls switch 22 to provide power to the active material element. When energized, the element 14 contracts, pulling the arms 20 toward each other and thereby elevating the bolsters 10. Other mechanical systems utilize gears, turnbuckles, pulleys and other machines to pivot or elevate the arms 20 to adjust the shape or profile of the bolsters 10. A hydraulic/pneumatic system such as the system 30 shown in FIG. 3, can include inflatable elements 32 disposed within the bolsters 10 that can be configured to adjust the shape or profile of the bolsters. The inflatable elements 32 are connected to a fluid source 36 by way of pumps 34 connected to a power supply 40. A controller 42 operates a switch 44 to energize the pumps as desired by the occupant. As is understood by one having skill in the art, the shape/material of the disclosed bolsters is not meant to be limiting beyond the limitation that they be adjustable within the current system.

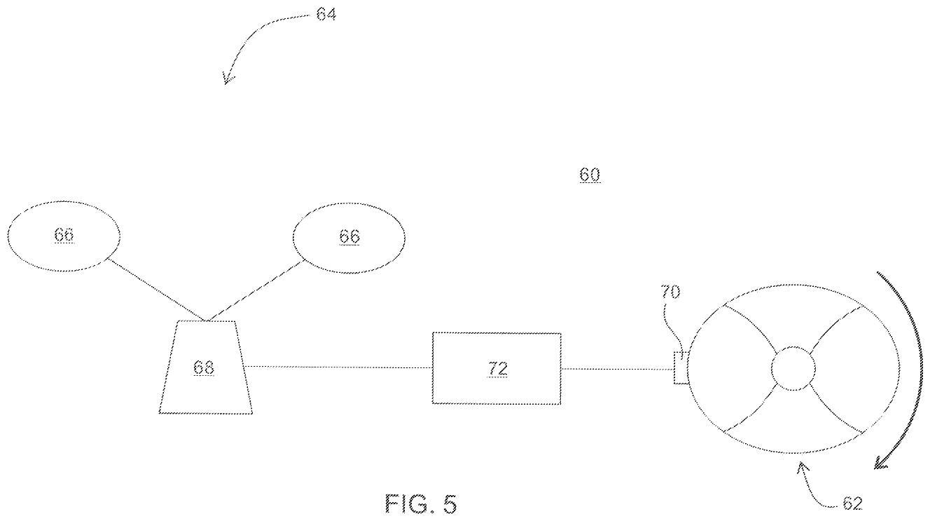

In the currently disclosed system, a bolster control system 60 is configured to control operation of an adjustable bolster system 64 within an adjustable seat, which is based on movement of a seat adjustment mechanism 62, such as a seat swivel mechanism as is depicted in the diagram of FIG. 5. A seat adjustment mechanism can be of any type and configuration, including a swivel mechanism that pivots the entire vehicle seat and swivel mechanisms that only pivot the seat bottom relative to a fixed position seat back. As can be understood by one skilled in the art, the only limitation is that the entire seat or parts of the seat be adjustable to allow movement of the seat occupant away from a neutral seat position. The adjustable bolster system 64 can include bolsters in the seat back and seat bottom, or in only one of the seat components. The adjustable bolster system 64 includes the bolsters 66 and an adjusting device 68, each of which can be of various types known in the art, such as the mechanical and pneumatic/hydraulic systems described above.

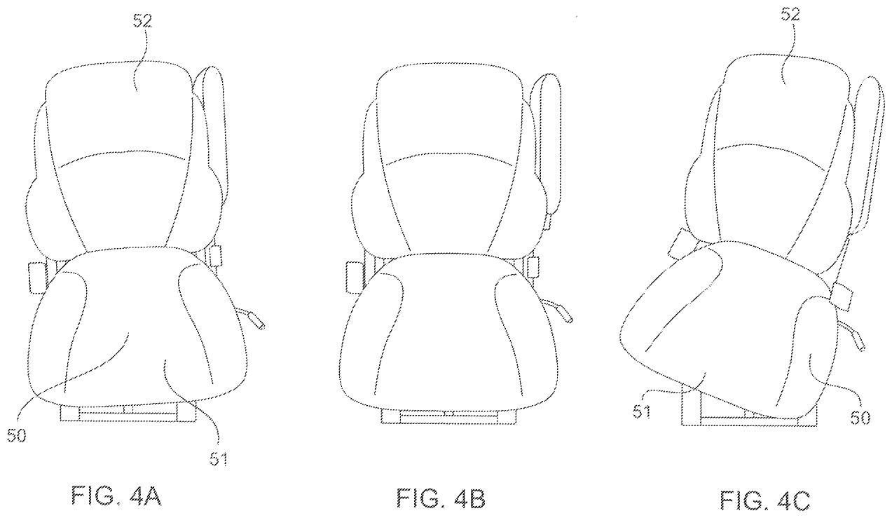

The bolster control system 60 of the present disclosure includes a sensor 70 that is arranged and configured to sense a position of the seat adjustment mechanism 62. The sensor 70 provides a signal to a controller 72 that evaluates the signal to determine whether the seat has been adjusted away from the neutral position (FIG. 4b, for example). Generally a neutral position of a seat is when the seat has not been pivoted from its front facing normal driving position or adjusted from a level surface or where the angle of inclination is 0 degrees. However, in some embodiments, a neutral position also encompasses a seat position that has been pivoted less than 5 degrees or where the angle of inclination is less than 5 degrees. If the seat has been adjusted from the neutral position, the controller 72 directs the adjusting device 68 to deactivate the bolsters 66. Thus, if the bolsters 66 are initially activated so that the bolsters are in their expanded or extended state, the controller 72 causes deactivation of the bolsters to return them to their neutral states. In this configuration, the bolsters do not impede the movement of the vehicle operator as he/she attempts to turn within the vehicle seat to get a full view of the rear of the vehicle. When the seat is returned to its neutral position, the controller 72 activates the adjustable bolsters 66 to the configuration that they had before the seat was adjusted.

The sensor 70 can be of any type capable of determining whether the seat adjustment mechanism 62 has pivoted away from the neutral position for the seat. The sensor 70 can be a mechanical switch that is activated by a component associated with the seat when the seat pivots away from neutral, or can be a mechanical roller in contact with a cylindrical surface of the seat swivel that activates a switch within the sensor. Activation of the switch can send an electrical signal or pulse to the controller 72. Alternatively, the sensor 70 can be electrical or optical to detect the position of the seat swivel without contacting the seat swivel. For instance, the sensor can be a Hall sensor or an optical sensor. The sensor 70 can be configured to generate a binary signal indicative of the seat swivel being in the neutral position of the seat swivel or being in a position different from the neutral position, without regard to how much the seat has pivoted. The binary signal could be based on a certain degree of pivot of the seat swivel so that the sensor only generates a signal when the seat has pivoted to a predetermined angle, such as the maximum movement angle of the seat. Alternatively, the sensor can be configured to provide a quantitative signal indicative of the amount that the seat swivel has pivoted from the neutral position.

The controller 72 can be any form of controller capable of receiving a signal from the sensor and generating a signal to actuate the adjusting device 68. In one embodiment, the controller 72 can be an electrical switch that is tripped in response to a signal from the sensor, in which the switch is opened to disconnect the adjusting device from an electrical power supply, thereby causing the bolsters to be deactivated. In another embodiment, the controller 72 can be an analog circuit that receives an electrical signal from the sensor and generates an appropriate signal to deactivate or re-activate the adjusting device accordingly. The controller 72 can be a digital controller implementing software commands to evaluate the signal from the sensor 70 and determine whether to deactivate or re-activate the adjusting device 68 and ultimately the adjustable bolsters 66. It is further contemplated that the controller 72 can be configured to specifically adjust the profile or shape of the bolsters in relation to the amount of pivot of the seat swivel. In this case, it may be desirable to retain some amount of bolster rather than completely deactivate the adjustable bolster, such as if the seat is not swiveled to its maximum extent. The controller 72 can also be configured to verify that a seat swivel has occurred, rather than a brief shifting of the seat position. Thus, the controller 72 can incorporate a timer to determine that the sensor signal indicative of a pivoting movement of the seat swivel has occurred over a predetermined time suggestive that the operator is indeed pivoting the seat for a rearward view.

The controller can be adapted to control multiple bolsters anywhere on the vehicle seat and to provide individual control of the multiple bolsters. For instance, it may be desirable to retain a certain amount of bolster in the seat back with no bolster in the seat bottom, or vice versa. Moreover, it may only be necessary to reduce the seat bolster on the side of the seat in the direction of the seat swivel, while the outboard bolsters remain in the operator selected configuration. The controller 72 may further be programmable by the vehicle operator to provide predetermined bolster shapes according to the vehicle operator's preferences. For instance, the operator may prefer a completely flat seat bottom (i.e., no bolster activation) when pivoting the seat to the right, and a partially extended bolster when pivoting to the left. In this instance, the controller 72 may be provided with a wired or remote user-input feature that allows adjustment or programming of the controller.

It is further contemplated that the sensor 70 and controller 72 can be purely mechanical. In this embodiment, the sensor can be a mechanical component, such as a cam, that engages the seat swivel mechanism or the seat. The controller can be a mechanical linkage connected to the adjusting device in a manner that alters the state of the adjusting device when the seat swivel is in motion. For example, the controller can be a linkage that is connected to the mechanical element of an electrical switch to pull the switch upon rotation of the seat swivel, thereby disconnecting the bolster device from the power supply, such as the versions shown in FIGS. 2 and 3. The adjusting mechanism and adjustable bolsters may be entirely mechanical with the mechanical linkage controller 72 directly connected to the bolster mechanisms.

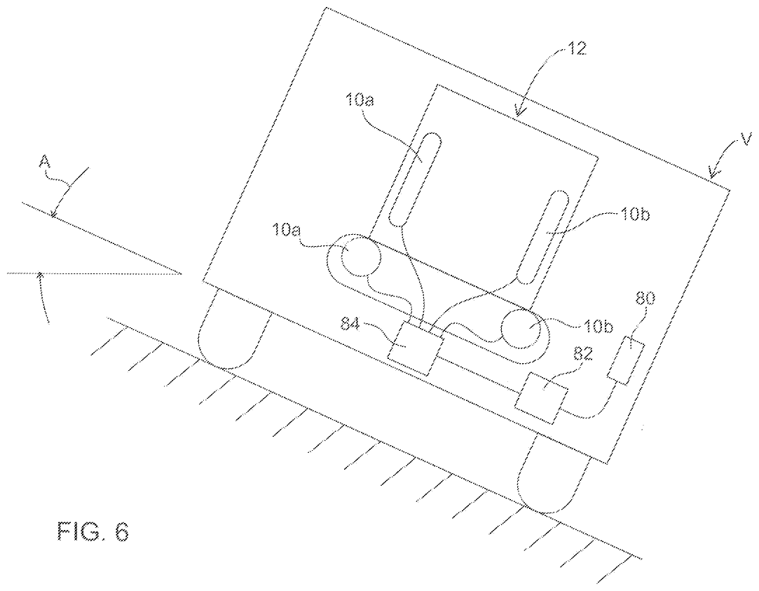

In another embodiment depicted in the diagram of FIG. 6, a vehicle V is operated at an angle of inclination A, such as when the vehicle is operating on sloped terrain. In this embodiment the vehicle V includes an attitude sensor 80 that is configured to sense the angle of inclination A of the vehicle, and more particularly the inclination of the vehicle laterally. The attitude sensor 80 provides a signal to a controller 82 that is configured to determine the attitude and degree of inclination of the vehicle and determine which of the bolsters 10a, 10b to activate. In the diagram of FIG. 6, the controller 82 would direct the adjusting device 68 to actuate the bolsters 10b on the low side of the vehicle V. The bolsters 10a on the high side can be deactivated or flattened as desired, or can remain in the operator-selected configuration. The controller 82 can determine the degree of extension of the bolsters 10b as a function of the magnitude of the angle of inclination A. Thus, for a small angle, the bolsters 10b need not be extended to their maximum shape. Alternatively, for a larger angle the bolsters may need to be fully extended to prevent the vehicle operator from sliding laterally off the seat 12.

The controller 82 can be configured to only activate the adjusting device 84 at a threshold value of the angle of inclination A. For instance, a vehicle operating at a five degree angle of inclination may not pose a significant risk of the operator sliding sideways within the seat 12. However, an angle greater than five degrees may create the slipping risk.

As with the embodiment of FIG. 5, the adjusting device 84 and bolsters 10a, 10b can be of a variety of types and configurations, including electrical, pneumatic/hydraulic and mechanical systems. The controller 82 and attitude sensor 80 can also be of various types and configurations, including electronic, electrical, pneumatic/hydraulic and mechanical systems. In one specific embodiment, the controller 82 is a “smart” device incorporating a computer processor operable to receive and interpret the signal from the attitude sensor 80. The “smart” controller can perform calculations or table look-ups to determine whether and to what degree to actuate all or any combination of the bolsters of the seat 12. The attitude sensor 80 may also be a “smart” device, such as a MEMS device or the attitude sensors used on smart phones and similar devices. The sensor may be associated with the controller, adjusting device, seat, vehicle or even the operator of the vehicle.

It is contemplated that the two embodiments shown in FIGS. 5 and 6 can be combined. In this combined system the controller is operable to actuate the bolsters in response to seat swivel as well as vehicle attitude. The controller can be configured to give precedence to the actuation of the bolsters to account for operating the vehicle at a lateral inclination.

The present disclosure contemplates a system for controlling the operation of an adjustable bolster for a vehicle seat based on whether an adjustable seat has been adjusted away from a neutral position. The system includes a sensor for determining the adjustment away from the neutral position, and a controller for adjusting the adjustable bolsters in response to that signal.

The present disclosure should be considered as illustrative and not restrictive in character. It is understood that only certain embodiments have been presented and that all changes, modifications and further applications that come within the spirit of the disclosure are desired to be protected.

What is claimed is:

1. A seat bolster control system comprising:
an adjustable seat, wherein the adjustable seat has an adjustable bolster;
a sensor capable of sensing a position of the adjustable seat;
a controller; and
an adjusting device in communication with the controller wherein the adjusting device controls adjustment of the bolster, wherein the controller is in communication with the sensor and the adjusting device.

2. The system of claim 1 wherein the adjusting device responds to an input from the sensor.

3. The system of claim 1 wherein the adjusting device responds to an input from a user.

4. The system of claim 1 wherein the adjustable seat has a neutral position and a non-neutral position.

5. The system of claim 4 wherein the bolster is adjusted when the adjustable seat is in the non-neutral position.

6. The system of claim 5 wherein the bolster adjustment is automatic based on the non-neutral position.

7. The system of claim 6 wherein the bolster adjustment is based on a percentage of movement of the adjustable seat from the non-neutral position.

8. The system of claim 5 wherein the bolster adjustment is preprogrammed.

9. The system of claim 1 wherein the sensor is integral to the adjustable seat.

10. The system of claim 1 wherein the controller directs the adjustment device to adjust the bolsters.

11. The system of claim 1 wherein the bolster is deactivated.

12. The system of claim 1 comprising more than one adjustable bolster.

13. The system of claim 12 wherein the more than one adjustable bolsters are adjustable independently of each other.

14. The system of claim 1 wherein the adjustable bolsters are adjusted by inflation.

15. The system of claim 1 wherein the sensor senses an altitude adjustment of the adjustable seat.

16. An active bolster method in a vehicle, comprising the steps of:
forming an adjustable seat with an adjustable bolster;
sensing an adjustment of the adjustable seat;
sending a signal to a controller for adjustment of the adjustable bolster;
sending a signal to an adjustment device for adjustment of the adjustable bolster; and
adjusting the bolster to allow a seat occupant to get a full view of the rear of the vehicle.

17. The method of claim 16 wherein the signal is an electrical signal.

18. The method of claim 17 wherein the signal is a mechanical signal.

19. The method of claim 16 wherein the adjustment device is a pneumatic device.
